(19) United States
(12) Patent Application Publication
(10) Pub. No.: US 2015/0081548 A1
(43) Pub. Date: Mar. 19, 2015

(54) METHODS AND SYSTEMS FOR MAKING MOBILE PAYMENTS

(71) Applicant: MDR Group LLC, Overland Park, KS (US)

(72) Inventor: David Martin Robinett, Overland Park, KS (US)

(21) Appl. No.: 14/461,173

(22) Filed: Aug. 15, 2014

Related U.S. Application Data
(60) Provisional application No. 61/866,283, filed on Aug. 15, 2013.

(51) Int. Cl. G06Q 20/32; H04M 3/493; G06Q 20/16

(52) U.S. Cl. CPC G06Q 20/322; G06Q 20/16; H04M 3/493
USPC 705/44

(57) ABSTRACT

Systems and methods for mobile payments are provided. A customer may interact with the system via a voice interface. A customer may verbally communicate with a merchant to determine details of a transaction. The customer need not provide sensitive financial information for the transaction nor have stored payment information previously with the merchant. Information pertaining to the transaction may be processed and payment confirmation may occur through communication with a payment gateway.

### CROSS-REFERENCE

This application claims the benefit of U.S. Provisional Application No. 61/866,283 filed Aug. 15, 2013, which application is incorporated herein by reference in its entirety.

### BACKGROUND OF THE INVENTION

Customers interact with remote merchants through different interfaces, such as the Internet. For example, customers often purchase items online. However, in some instances, this can be challenging. For example, while customers are on the go, or do not have access to a computer, it may still be desirable for the customer to make a purchase with a remote merchant. In one example, it may be dangerous for a customer to operate a motor vehicle and try to conduct a transaction via a visual interface.

Thus, a need exists for additional system and methods for making mobile payments, where a customer may not have to rely on visual interfaces or enter data by typing or clicking

### SUMMARY OF THE INVENTION

An aspect of the invention is directed to a computer implemented method for making mobile payments comprising: receiving a caller identification and a caller authentication from a caller, said caller using a calling device with an audio receiver; receiving a spoken merchant identifier from the caller, via the audio receiver of the calling device; connecting the caller with the merchant based on the spoken merchant identifier; receiving transaction information between the caller and the merchant from the merchant; and sending the caller identification, caller authentication, and at least some of the transaction information to a payment gateway.

An additional aspect of the invention is directed to a computer implemented method for making mobile payments comprising: receiving a caller identification of a caller from an interactive voice response system, said caller using a calling device with an audio receiver; receiving transaction information between the caller and the merchant from the merchant; sending the caller identification and at least some of the transaction information to a payment gateway, wherein the caller's sensitive financial information is stored in a memory accessible, using the caller identification, by the payment gateway and not accessible by the merchant; and receiving, from the payment gateway, a payment confirmation or rejection from the payment gateway, and sending the payment confirmation or rejection to the merchant.

Additional aspects and advantages of the present disclosure will become readily apparent to those skilled in this art from the following detailed description, wherein only exemplary embodiments of the present disclosure are shown and described, simply by way of illustration of the best mode contemplated for carrying out the present disclosure. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows an example of a mobile payment system in accordance with an embodiment of the invention.

FIG. 2 shows an example of a mobile payment server in accordance with embodiments of the invention.

FIG. 3 shows examples of information stored in memory accessible by the mobile payment server in accordance with embodiments of the invention.

FIG. 4 shows an example of a voice interface interacting with a back end interface in accordance with embodiments of the invention.

FIG. 5 shows an example of a mobile payment method in accordance with embodiments of the invention.

### DETAILED DESCRIPTION OF THE INVENTION

While preferable embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

The invention provides systems and methods for mobile payments and transactions. Various aspects of the invention described herein may be applied to any of the particular applications set forth below or for any other types of transactions. The invention may be applied as a standalone device, or as part of an integrated payment system. It shall be understood that different aspects of the invention can be appreciated individually, collectively, or in combination with each other.

Systems and methods for making mobile payments and transactions may include a voice interface, and a back end which may permit processing of payments. For example, a customer may interact with a system only via voice without requiring the use of a visual display device or manual (by hand) data entry. A customer may interact with a merchant to determine the details of the transaction (e.g., item being purchased, price). Systems may be provided that may authenticate a user and process payments relating to the transaction. Such processing may occur without requiring the customer to provide a credit card number or other sensitive financial information during the transaction.

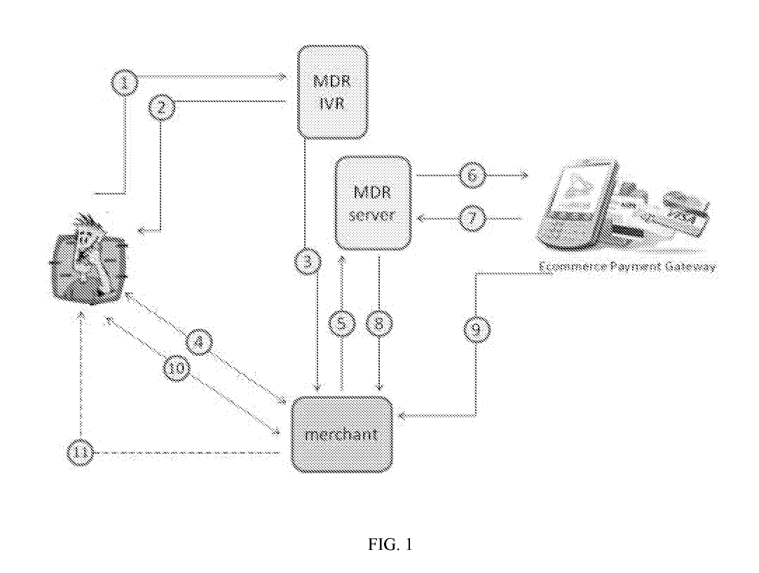

FIG. 1 shows an example of a mobile payment system in accordance with an embodiment of the invention. A customer may interact with a mobile payment interactive voice response (IVR). A customer may also interact with a merchant. A mobile payment server may interact with the mobile payment IVR and the merchant. The mobile payment server may also interact with a payment gateway.

As illustrated, the following steps may occur: 1) Caller dials a --- (e.g., 250) on their mobile phone, and connects to MDR IVR; Caller speaks the Merchant name or assigned Spoken Keyword; 2) IVR asks Caller for their mobile wallet PIN (to prepare for potential purchase transaction) & Caller speaks their PIN number (IVR verifies PIN heard); Biometric voice authentication or other form of authentication could occur at this point; 3) Voice call is transferred to Merchant; 4) Caller and Merchant agree on item to be purchased and total price; 5) Merchant sends transaction information to MDR server (Caller ID, Item, Price, etc.); Caller waits for payment confirmation; 6) MDR server sends transaction information to Payment Gateway (adding PIN & Merchant ID); 7) Payment Gateway processes payment and sends confirmation (or rejection) to MDR server (or directly to merchant server); 8) MDR server sends payment confirmation to Merchant (if not done in 7)); 9) Payment Gateway sends payment to Merchant (real-time or delayed); 10) Merchant tells Caller that their payment was accepted (or rejected); 11) Merchant initiates delivery of purchased item or service. Such steps are provided by way of example only and are not to be considered limiting. In some embodiments, step (5) may include a merchant receiving the --- (e.g., 250) number on a dedicated inbound phone number. The merchant screen may show the caller ID of the individual (which may optionally be sent from the MDR server) and/or to whom the merchant is talking (e.g., via live attendant or automated attendant). After agreeing on the merchant, the merchant may enter the transaction amount on a special screen (e.g., the merchant screen showing the information) or into their regular order entry system. The special screen may also receive other transaction information, such as an item description field or transaction ID. If the exact information is entered into the screen automatically, a human attendant may only be required to verify and click SEND. The merchant may click to SEND the transaction information back to the MDR server. Further descriptions, embodiments, or examples of the steps described herein are provided in greater detail below.

A customer may call a mobile payment IVR 1). In some instances, a customer may use an abbreviated dialing code (ADC) to call the IVR. For instance, the customer may use the customer's telephone to input the ADC. In one example, the call is sent with a caller access code which may start with a or *. In some instances, the ADC is 2, 3, 4, or 5 digits long. For example, the caller may input 250 to be connected to the IVR. In other examples, the caller may use any phone number (e.g., toll-free number, seven digit number, ten digit number including area code, international number). Any known calling technique may be implemented. See, e.g., U.S. Pat. No. 6,397,057, U.S. Patent Publication No. 2003/0130864, U.S. Patent Publication No. 2006/0223576, U.S. Patent Publication No. 2004/0014454 which are hereby incorporated by reference in their entirety.

A customer may use any phone to make the call. The phone may use a landline. The phone may be wireless phone, cell phone, or smartphone. The phone may communicate over a telecommunications network. The phone may have a user interface (e.g., keypad, touchscreen, keys, buttons, dial) through which a user may enter numbers. The phone may have an audio receiver through which the user may speak through the phone. The audio receiver may transform sounds to electronic signals representative of the sound. In some instances, a device, such as a computer having a microphone, may be used to make the call. Any device using an audio receiver may be used to make the call (e.g., personal computer, laptop, tablet, mobile device, personal digital assistant). Voice systems capable of making calls over a network such as the Internet (e.g., Skype) may be used to make calls. Any description herein of a phone or call may apply to any communication technique described herein or known in the art. A calling device may be a phone, device (e.g., computer with microphone), or any other device with audio receiver.

A customer may be connected to the mobile payment IVR. In some embodiments, the IVR may be able to access the customer's caller ID. For example, the phone number that the customer is calling from may be accessible by the IVR. For example, if the customer has mobile number 222-222-2222, the IVR may be able to access that number. The IVR may be able to access the customer's landline number, mobile number, smartphone number, or number of any other device the customer is calling from. The IVR may be able to access the number without requiring any separate input from the customer. The customer's phone number may be the customer's caller identification which may be used to store and/or index information relating to a transaction.

If the IVR is unable to access the customer's number, the IVR may optionally ask the customer for the customer's number. The customer may be able to say the number out loud, or may enter the number (e.g., via keypad) through the customer's phone. Alternatively, the IVR may ask for any other identifying information from the customer (e.g., a customer's personal unique ID number, customer's name, etc.). In some instances, the caller identification may match the customer's identification for a payment gateway. For example, if the customer has an account with a payment gateway (e.g., PayPal, Stripe), the caller identification may be the customer's phone number or user name with the payment gateway (e.g., PayPal, Stripe). In another example, the payment gateway may use a unique username to identify a customer. The customer may then be asked to speak or enter the customer's username.

When the customer is interacting with the IVR, the customer may be interacting via voice only, or through a combination of voice and entered data (e.g., numbers entered on keypad, buttons, dial, or any other interface). The IVR may provide audible prompts to the customer. For example the IVR may ask the customer for a merchant identifier or keyword. The IVR may include an automated system that may provide audible questions or information to the customer and await audible responses from the customer. The customer may provide the IVR with a merchant name or other merchant identifier (e.g., merchant number, keyword, etc.). The customer may speak the merchant name (or other identifier) to the IVR. The IVR may recognize the merchant name and be capable of transferring the customer to the identified merchant.

The IVR may ask a customer for a caller authentication 2). For example, the IVR may ask the customer for a personal identification number (PIN). Any description herein of caller authentication or PIN may also apply to other types of caller authentication (e.g., password, pass phrase, musical line, biometric individual voice verification). The customer may provide the caller authentication by speaking. Alternatively, the caller may enter the caller authentication via the phone (e.g., entering numbers into a keypad). In some instances, the caller authentication may match the customer's authentication for a payment gateway. For example, if the customer has an account with a payment gateway (e.g., PayPal, Stripe), the caller authentication may be the customer's PIN with the payment gateway (e.g., PayPal, Stripe). In another example, the caller authentication for a payment gateway may be a password. The customer may say or enter the password.

The customer may be transferred to the merchant 3). The customer may be transferred to a merchant based on the spoken merchant name or other identifier. In some instances, the IVR may be capable of transferring the customer to one of a plurality of possible merchants. The IVR may select the merchant from the plurality that matches the merchant name or other identifier. In some embodiments, if the IVR is unable to determine which merchant the customer ought to be transferred to, the IVR may ask the customer to repeat the merchant identifier, or enter the merchant identifier via the phone (e.g., enter in a number into a keypad). In some embodiments, the IVR may offer suggestions to the customer if the IVR is uncertain of which identifier the customer stated (e.g., merchant asking “Did you mean Merchant X?” if the customer said a keyword close to Merchant X). The customer's voice call may be transferred to the merchant so that the customer is speaking directly with the merchant.

The customer may interact with the merchant to agree on a transaction 4). In some instances, all of the customer's interactions with the merchant may be via voice. The customer may be speaking with a merchant representative (e.g., human) and/or interacting with an IVR/automated attendant of the merchant. Any combination of automated or human interaction between the customer and merchant may be provided. The customer may interact with the merchant only via voice. Alternatively, the customer may interact with the merchant via a combination of voice and entering information via the customer's phone (e.g., pressing numbers on a keypad).

In some instances, the transaction between the customer and merchant may be an agreement for purchase of an item or service. For example, the customer may buy goods from the merchant for a price. In some instances, the transaction may be a financial transaction that may involve the customer paying the merchant. In some instances, the merchant may be a non-profit and the customer may be providing a financial donation to the merchant. The financial amount of the transaction may be agreed upon by the customer and merchant. The agreed upon amount may be described in a unit of currency (e.g., dollar, euro, pound, yen, etc.).

In some embodiments, the customer need not provide sensitive financial information to the merchant. For example, the customer may agree on a transaction with the merchant without the merchant receiving the customer's credit card number, debit card number, prepaid card number, gift card number, or bank routing number. Similarly, the customer need not provide sensitive financial information to the IVR. Sensitive financial information stored with another entity (e.g., payment gateway) may be leveraged. Sensitive financial information may be stored in one or more memory storage units (e.g., databases, servers), that may be accessed by the payment gateway. The sensitive financial information in the memory storage units may optionally not be accessed by the merchant, IVR, and/or a mobile payment server.

The merchant may send transaction information to a mobile payment server 5). In some instances, the merchant may send information about the price. The merchant may send the information about the price in a unit of currency (e.g., dollar amount). The merchant may send additional information about the transaction such as the item or service purchased, or donation provided. For example, if the customer bought a pair of shoes for $50, the merchant may inform the server that the price was $50, and that the pair of shoes was purchased. In another example, if the customer made a $30 donation to a Wildlife Rescue fund, the merchant may inform the server that the transaction amount was $30, and that a donation was made to the Wildlife Rescue fund. In some embodiments, the merchant may send information about the customer to the server. For example, the merchant may provide the customer's caller identification information (e.g., customer's phone number) and/or caller authentication information (customer's PIN). In some instances, the IVR may have provided the customer's caller identification information and/or caller authentication information to the merchant. In other instances, the merchant may be capable of collecting the customer's caller identification information and/or caller authentication information. Alternatively, the IVR may provide the customer's caller identification and/or caller authentication information directly to the mobile payment server. In some instances, the merchant need not ever receive sensitive information, such as the customer's caller authentication information (e.g., PIN).

The customer may be on the phone with the merchant while the back end payment processing is occurring. The customer may be on the phone with the merchant while the merchant is sending information to the mobile payment server. The back end processing may occur quickly.

The mobile payment server may include one or more servers. One or more merchants may communicate with the server at a time. The merchants may communicate with the server sequentially or simultaneously. The server may have relationships established with multiple merchants, and may assist with processing payments for various merchants.

The server may have a processor and/or memory. The memory may permit the server to store information about a transaction. One or more databases may be provided for the server or accessible by the server. The server may store information about transactions, customers and/or merchants using the mobile payment system. In some instances, information such as customer caller identification, customer authentication (e.g., PIN), time stamps, transaction price, description of transaction (e.g., transaction item), merchant identification, or other information may be stored. In some instances, credit card information, debit card information, prepaid card information, gift card information, routing number, or other sensitive financial information is not stored on the one or more servers. Such information may be stored at a payment gateway. In some instances, such information is not directly accessible by the server. Alternatively, in some embodiments, such information may be stored at the server or accessible by the server. In some embodiments, the servers may store a token or pointer that may be used to access an account on a payment gateway.

Optionally, merchants may have accounts with the mobile payment system. The merchant account information may be stored in a memory of the mobile payment server. Similarly, servers may or may not have pre-established relationships with certain payment gateways. Information pertaining to relevant payment gateways may be stored in a memory of the mobile payment server.

A programmable processor of the server may execute one or more steps as provided therein. Any actions or steps described herein may be performed with the aid of a programmable processor. Human intervention may not be required in automated steps. The programmable processor may be useful for analyzing transaction information. The server may also include memory comprising non-transitory computer readable media with code, logic, instructions for executing one or more of the steps provided herein. For example, the server(s) may be utilized to confirm a transaction with a payment gateway. The server may communicate with a payment gateway and/or the merchant.

The server may have a clock or other time keeping device. The server clock may permit the server to create timestamps for various actions that may occur. For example, the server clock may create timestamps for when information is received (e.g., from an IVR, merchant, and/or payment gateway). The server clock may keep track of current time, and compare the current time with timestamps to determine how long ago certain actions may have taken place.

The server may have a display. A user may be able to interact with the server via a user interface. Alternatively, the server may be capable of operating without user interaction.

A mobile payment server may send information to a payment gateway 6). The payment gateway may be an ecommerce application service provider (e.g., PayPal, Amazon Payments, Square, Google, Citibank, HSBC). The payment gateway may authorize payments for merchants (e.g., online retailers, e-businesses, bricks and clicks, or traditional brick and mortar). Payment gateways may protect sensitive financial information (e.g., credit card numbers, debit card numbers, prepaid card numbers, gift card numbers, routing numbers). The payment gateway may store sensitive financial information of a customer and use the sensitive financial information to pay one or more merchants, without requiring the merchant to have access to the sensitive financial information. The payment gateway may serve as a mobile wallet.

In some embodiments, the mobile payment server may send transaction information to the payment gateway. In some instances, the transaction information may include a caller identification, caller authentication, and transaction price. Examples of additional information may include merchant identification. In some instances, additional information about the transaction, such as item or service being purchased may be provided. The mobile payment server may have received the information being shared with the payment gateway from the merchant, the IVR, or any combination thereof. In some embodiments, the mobile payment server may use a token or pointer stored at the mobile payment server side to access an account with the payment gateway. In some instances, the token or pointer may be accessed using the caller identification. Caller authentication may or may not be required to access the token or pointer. The token or pointer may be used as a caller authentication at the payment gateway.

The payment gateway may have one or more device that may have a memory and/or processor. The memory may store account information about customers. The memory may store sensitive financial information of a customer (e.g. credit card numbers, etc.). The memory may store other account information for a customer (e.g., customer name, contact information, historical transaction data). The memory may store non-transitory computer readable media comprising code, logic, or instructions for performing one or more step. The processor may be capable of performing one or more step. The processor may perform the step in accordance with the non-transitory computer readable media. The processor may determine whether to confirm a payment for a transaction. The processor may initiate communications with other financial entities (e.g., banks, credit card companies).

Communications between the mobile payment server and the payment gateway may occur over a network. For example, the mobile payment server and the payment gateway may communicate over a local area network (LAN), wide area network (WAN) such as the Internet, telecommunications network, data network, or any other network. The mobile payment server and the payment gateway may communicate directly with one another.

The payment gateway may process the payment and may send a confirmation (or rejection) to the mobile payment server 7). The payment gateway may use the caller identification and caller authentication to access the caller's account with the payment gateway. The payment gateway may have financial information for the customer. The payment gateway may process the transaction for the price that was indicated. If the customer has sufficient funds, the payment may be confirmed. If the payment gateway detects that the customer does not have sufficient funds or other red flags, the payment may be rejected.

The mobile payment server may send the confirmation (or rejection) back to the merchant 8). Notification of the payment confirmation may be sent via the server without direct contact between the payment gateway and the merchant. In some instances, the mobile payment server may have merchant identification information. Thus, the mobile payment server may be able to track which merchant receives the confirmation of payment for the selected transaction.

The payment gateway may provide the payment to the merchant 9). This may occur in real-time or may be delayed (e.g., may occur within milliseconds, seconds, minutes, hours, or days of the payment confirmation). The payment gateway may provide the payment to the merchant matching the agreed upon price between the merchant and the customer. The payment gateway may deduct the payment from the customer's account, or may request a payment from a financial institution associated with the customer. In some instances, the payment gateway may deduct a surcharge from the customer for use of payment gateway. In another example, the surcharge may be deducted from a merchant for use of the payment gateway.

When the merchant has received confirmation (or rejection) of the payment, the merchant may let the customer know that his or her payment was accepted (or rejected) 10). In some embodiments, the back end processing of the payment may occur rapidly. The customer may be on the phone with the merchant when the merchant informs the customer of whether the payment has gone through. In some instances, the amount of time between when a customer and merchant have agreed upon a price and other details of a transaction, and when the customer receives confirmation (or rejection) of payment may be less than or equal to about 10 minutes, 5 minutes, 3 minutes, 1 minute, 45 seconds, 30 seconds, 15 seconds, 10 seconds, 5 seconds, 3 seconds, 2 seconds, or 1 second. The back end communications with the server and/or payment gateway may occur in real-time. The customer may still be in on the original phone call with the merchant when the customer receives confirmation. In one example, the customer may agree on a transaction with a merchant, and not have to wait long before the merchant comes back and says whether the customer's payment has been confirmed or not.

After confirmation of payment, a merchant may initiate delivery of a purchased item or service to the customer 11). In some instances, some delay may be provided before the customer receives the purchased item or service. Alternatively, the purchased item or service may occur in real-time (e.g., electronic delivery).

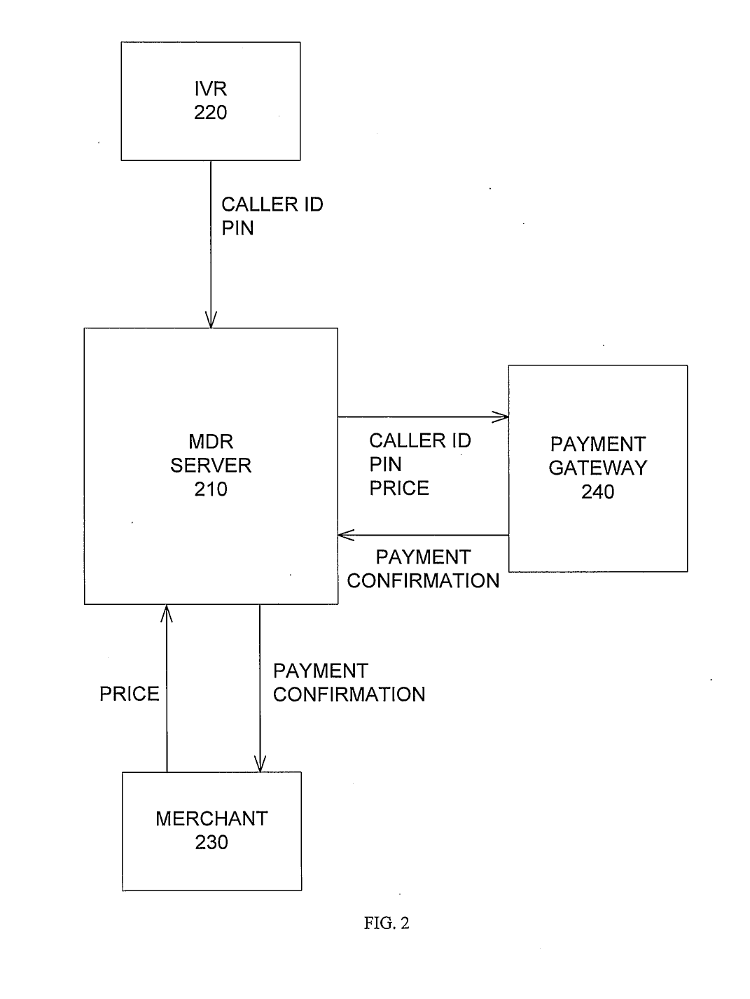

FIG. 2 shows an example of a mobile payment server 210 in accordance with embodiments of the invention. The mobile payment server may interact with one or more entities. For example, the mobile payment server may interact with an IVR 220, merchant 230, and/or payment gateway 240.

In one embodiment, the IVR may collect information from the customer. For example, the IVR may get the customer's caller identification (e.g., customer phone number) and caller authentication (e.g., customer's PIN). The merchant may collect information from the customer. For example, the merchant may get information about a transaction (e.g., price associated with transaction, items or services purchased, donations made, description of transaction). The merchant may or may not get caller authentication information (e.g., the merchant may not get the customer's PIN). In some instances, the merchant may or may not get customer caller identification (e.g., the customer's phone number). In some embodiments, the IVR may provide the customer caller identification to the merchant. Alternatively, the merchant may directly collect the customer caller identification.

The information may be collected by the IVR and/or merchant in any order. For example, a caller ID may be collected by the IVR. Then the IVR may collect the PIN prior to the merchant getting transaction information from the customer. Alternatively, the IVR may collection the PIN after the merchant has received transaction information from the customer.

The mobile payment server may be provided with a customer's caller identification, customer identification, transaction price, merchant information and/or other transaction information. The information may be provided from an IVR, a merchant, or any combination thereof. The server may or may not interact directly with the customer.

In one example, the IVR may provide the mobile payment server with the customer's caller ID and PIN. The merchant may provide a transaction price and/or merchant ID. The merchant may optionally provide additional transaction information (e.g., what items were purchased). In another example, the IVR may provide the server with a customer's PIN and the merchant may provide the server with the customer's caller ID, transaction price, merchant ID and/or additional transaction information. In some instances, some of the information may be provided from multiple sources. For example, both the IVR and the merchant server may send a caller ID to the server. The caller ID may serve as an index for information stored relating to a transaction. Alternatively, a different transaction identifier may be used.

The mobile payment server may use the collected information to confirm a payment with a payment gateway. For example, the server may use a caller ID, PIN, and price to confirm a payment with the payment gateway. The caller ID may be used to identify the customer and the PIN may be used to authenticate the customer with the payment gateway. In one example, any caller identification used by the payment gateway and any caller authentication used by the payment gateway may be collected and/or conveyed. The caller identification and caller authentication information collected by the server may match the type of caller information and authentication information that is used to authenticate a user at the payment gateway. The price of the transaction may be used to determine the amount that needs to be approved. In other examples, the payment gateway may or may not need additional information about the transaction, such as a merchant identifier or information about the items or services that were purchased. In some instances, only a subset of the information collected at the server is sent to the payment gateway to process the payment.

The mobile payment server may receive a payment confirmation (or rejection). The mobile payment server may inform the merchant of the payment confirmation (or rejection). In some instances, the server may inform the merchant according to a merchant identifier associated with the transaction. In some instances, the server may be capable of communicating with multiple merchants simultaneously, so a merchant identifier may be used to help identify which merchant to inform.

In some embodiments, information may be provided to the server along with a time stamp and/or indication of time. For example, a customer PIN may be provided to the server from an IVR. A timestamp may be provided with the PIN indicative of when the PIN was created. Alternatively, the timestamp may be provided at the server end indicative of when the PIN was received at the server. In some instances, some of the information provided to the server may remain at the server for a limited amount of time and may expire. The timestamp may provide an indicator of the beginning of the amount of time, and may assist with determining when information ought to expire. For example, the PIN may expire after a certain amount of time (e.g., on the order of weeks, days, hours, minutes, or seconds). After a certain amount of time has passed after the timestamp was received, the PIN may be removed from the server memory. A clock or other timekeeping device provided at the server may assist with determining how much time has elapsed. The server may calculate the difference between a current time indicated by the server clock and the timestamp to determine the amount of time that has elapsed. This may help provide security for information provided to the server. After its purpose has been fulfilled (e.g., used for a transaction) it may be undesirable to keep certain information with the server long-term. Alternatively, certain information may remain with the server. Any of the other information (e.g., caller ID, merchant ID, price, item) may expire after a predetermined amount of time, or may remain on the server. For instance, after a predetermined period of time has elapsed (e.g., from the timestamp time), the PIN or other caller authentication information may be removed from memory of the server.

In some instances, the timestamp may be used to help with identifying information pertaining to the same transaction collected from different sources. For example, a caller ID and a PIN may be received from an IVR at a first time T1. A caller ID, price information, and merchant identification information may be received from a merchant at T2. In some instances, the caller ID may be used to match the two parts of the transaction. If the caller ID of the information from the IVR matches the caller ID from the merchant, the caller ID, PIN, price information, and merchant identification may be deemed to belong to the same transaction and may be associated with one another. In some embodiments, the timestamps T1 and T2 may be compared. If the difference between T1 and T2 fall within a predetermined threshold, then the two portions may be deemed to belong to the same transaction. If the difference between T1 and T2 exceeds a predetermined time threshold, the two portions may be deemed as belonging to different transactions. For example, if too great a time has elapsed (e.g., difference between T1 and T2 is too great), then the portion from the IVR may have been from a different transaction conducted using the same customer phone number. For example, a customer may conduct a first transaction with a first merchant using the customer's phone. The customer may then conduct a second transaction with a second merchant using the same customer's phone. If using the customer phone number or other caller identification information as the index, the timestamps may help discern which transaction information belongs together.

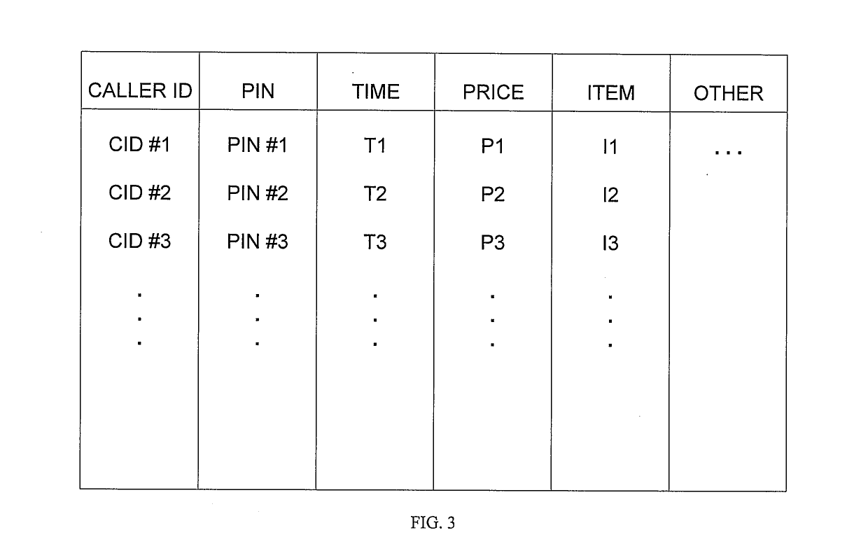

FIG. 3 shows examples of information stored in memory accessible by the mobile payment server in accordance with embodiments of the invention. In one example a caller ID (e.g., customer phone number), PIN, timestamp, transaction price, item information, merchant information, and/or any other information may be stored in memory.

In some instances, the information may only be stored for a limited amount of time. After a certain amount of time has passed, some or all of the information relating to a transaction may be deleted. In some examples, the timestamp may be reviewed to determine whether the timestamp is old enough to have exceeded an expiration threshold. The timestamp time may be compared with a clock time of the server. The difference between the timestamp time and the server clock time may be taken and compared. If the amount of time that has elapsed is greater than the expiration threshold, the selected related information may be deleted. For example, if Current Server Clock Time minus T2 is greater than Expiration Threshold, PIN 2 may be deleted. Other information such as the entire row may or may not be deleted.

Optionally, a caller ID may serve as an index for a transaction record. For example, an IVR may provide the server with CID 1 and PIN 1. A merchant may provide the server with CID 1, P1 and I1. The caller IDs may be compared. If the caller IDs match, then the information may be associated with one another as part of the transaction. In some instances, timestamps relating to when CID 1 and PIN 1 were received, and when CID 1, P1, and I1 were received may be compared to determine whether they really belong to the same transaction, or a different transaction that occurred at a different using time, but having the same CID 1. Alternatively, other information may be used as an index of the transaction records.

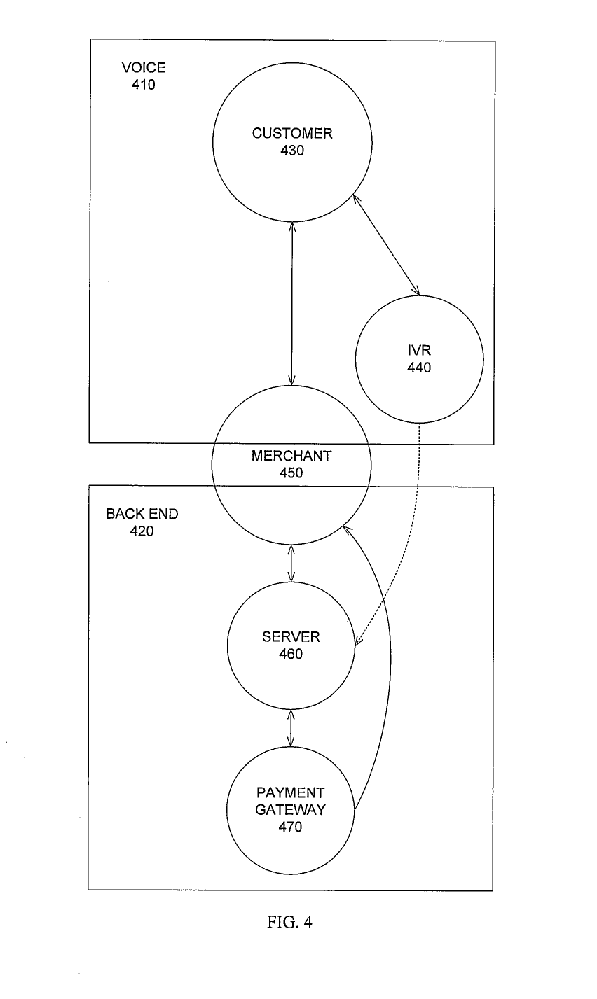

FIG. 4 shows an example of a voice interface interacting with a back end interface in accordance with embodiments of the invention. Various entities may be interacting with one another in a mobile payment system. For example, a customer 430 may interact with an IVR 440 and a merchant 430. The IVR and merchant may be owned and/or operated by different entities, or may be owned and/or operated by the same entity. In some instances, all interactions provided by the customer may be via voice interaction. For example, after the call is placed, the customer may speak with the IVR and the merchant. The customer may communicate via spoken word to identify a merchant and conduct a transaction with the merchant without requiring use of a visual display or interface. In some instances, the customer may supplement interaction with entry into the customer's phone (e.g., entering numbers into the customer's keypad). Alternatively, the customer only uses voice communications. This may be advantageous in situations where the customer's eyes may be taken up with other activity (e.g., while the customer is driving), when the customer's hands are occupied (e.g., carrying items) or at other times where it may be more convenient for the customer to just speak.

In some embodiments, a mobile payment server 460 may manage back end transactions. The server may communicate with a merchant 450. The server optionally may communicate with the IVR 440. In some instances, the server and IVR may be owned and/or operated by the same entity. Alternatively, they may be owned and/or operated by a different entity. In some instances, the functions of the server and IVR may be served by the same entity. The server and merchant may be owned and/or operated by different entities. In some instances, the IVR may provide information to the server without the server providing information to the IVR. The merchant may communicate directly with the server. Two-way communication may be provided between the merchant and the server. The communications may occur over a network. The server may communicate with a payment gateway 470. Two-way communication may be provided between the server and the payment gateway. The communications may occur over a network. The server and payment gateway may be owned and/or operated by different entities or the same entity. In some instances, sensitive financial information (e.g., credit card number, debit card number, prepaid card number, gift card number, bank routing number) may be provided on the payment gateway side without being provided on the server side. Alternatively in some instances, the server may incorporate some of the functionality of the payment gateway and/or may include sensitive financial information.

In some instances, a transaction may occur with sensitive financial information remaining on the payment gateway side. The IVR, merchant, and/or server need not access the sensitive financial information. The customer need not provide such information (e.g., credit card number) while making the financial transaction. The customer may take advantage of pre-stored information provided at the payment gateway. The payment gateway may function as an electronic or mobile wallet. This may be advantageous in situations where the customer may be in public and may not want to say the customer's credit card number out loud into the phone. This may also be convenient in situations where the customer may not have the customer's credit card with him or her, when he or she does not recall the number.

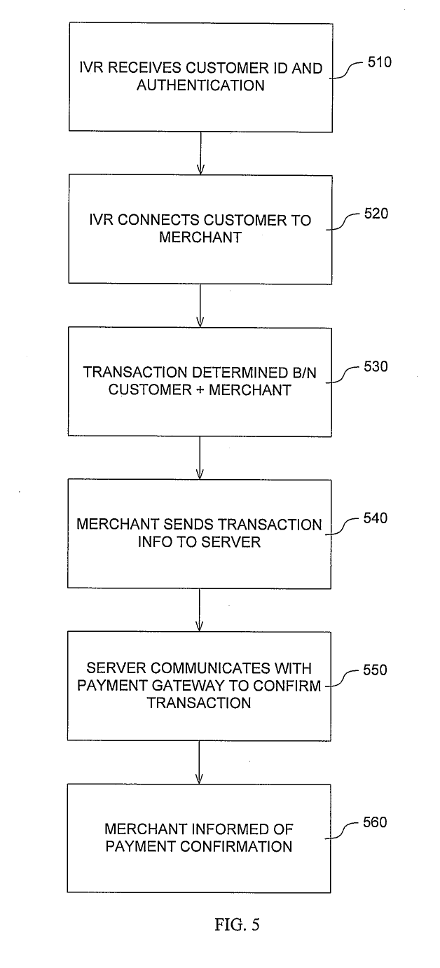

FIG. 5 shows an example of a mobile payment method in accordance with embodiments of the invention. Any of the steps described herein may be optional, or may occur in different orders. One or more of the steps described herein may be performed with aid of a processor. One or more of the steps describe may incorporate the use of a telephone.

An IVR may receive a customer identifier and authentication information 510. For example, the IVR may receive a customer's caller ID (e.g., customer phone number) and PIN. This may occur when a customer has called the IVR using an abbreviated dialing code or regular telephone number.

The IVR may connect the customer to a merchant 520. The customer may be connected to the merchant before or after providing the customer's PIN.

A transaction may be determined between the customer and merchant 530. The customer may be on the phone with the merchant. The customer may communicate via a merchant representative or with an automated system. Transaction information, such as price of an item or service, and/or the description of the item or service may be determined and known by the merchant.

The merchant may send transaction information to a server 540. The merchant may optionally send a customer identifier to the server as well. The merchant may have collected the customer identifier or may have received the customer identifier from the IVR.

The server may communicate with a payment gateway to confirm the transaction 550. The server may provide information that the server received from the IVR and/or merchant. For example, the server may provide a customer identifier and authentication information, which may cause the customer account to be accessed at the payment gateway. The server may also provide transaction information, such as the price, which may be processed for payment.

The merchant may be informed of payment confirmation 560. The server may inform the merchant of the payment confirmation, which the merchant may relay to the customer and/or cause the merchant to initiate delivery of an item or service to the customer.

The systems and methods provided herein may permit voice interaction of a caller with a system. A caller may conduct a transaction with a merchant without requiring a visual display or interface. The caller may not need to provide the merchant with the caller's financial information during the course of the transaction (e.g., the caller does not need to recite the caller's credit card number or similar information to the merchant). This may be advantageous in situations where the caller may not have access to a device with a visual display or when the caller is in a situation where the caller cannot pay attention to a visual display. This may also be advantageous in situations where the caller may not wish to provide the merchant with sensitive financial information, or if the caller cannot recall the sensitive financial information in the moment. The system may advantageously access a payment gateway on the back end to handle the financial transaction with the merchant, without having to deviate from verbal communications with the merchant. The systems and methods may be provided in a seamless manner that may permit a caller to just carry out a voice-driven interaction with the merchant, while the back end handles the payment. The back end may handle the payment in real time.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A computer implemented method for making mobile payments comprising:
receiving a caller identification and a caller authentication from a caller, said caller using a calling device with an audio receiver;
receiving a spoken merchant identifier from the caller, via the audio receiver of the calling device;
connecting the caller with the merchant based on the spoken merchant identifier;
receiving transaction information between the caller and the merchant from the merchant; and
sending the caller identification, caller authentication, and at least some of the transaction information to a payment gateway.

2. The method of claim 1 wherein the caller identification is a phone number of the calling device that the caller is dialing from.

3. The method of claim 1 wherein the caller authentication is a personal identification number (PIN).

4. The method of claim 1 wherein the at least some of the transaction information includes a price of an item or service that the caller is purchasing from the merchant.

5. The method of claim 1 further comprising receiving a payment confirmation or rejection from the payment gateway, and sending the payment confirmation or rejection to the merchant.

6. The method of claim 5 wherein the merchant does not have access to the caller's sensitive financial information, wherein the sensitive financial information comprises one or more of the following: caller's credit card number, debit card number, prepaid card number, gift card number, or bank routing number.

7. The method of claim 6 wherein the caller's sensitive financial information is stored in a memory accessible by the payment gateway and not accessible by the merchant.

8. The method of claim 5 wherein the payment gateway uses the caller identification and caller authentication to access the caller's account at the payment gateway, wherein the caller's account includes financial information for the customer that is used in combination with the transaction information that is sent to the payment gateway to determine whether the caller has sufficient funds for a proposed transaction with the merchant, and wherein the payment confirmation from the payment gateway is sent when the payment gateway determines that the caller has sufficient funds and the payment rejection from the payment gateway is sent when the payment gateway determines that the caller does not have sufficient funds.

9. The method of claim 5 further comprising sending the payment confirmation or rejection to the merchant while the caller is connected with the merchant.

10. The method of claim 1 wherein the caller communicates via spoken words to identify the merchant and conduct a transaction with the merchant, without requiring use of a visual display or interface.

11. A computer implemented method for making mobile payments comprising:
receiving a caller identification of a caller from an interactive voice response system, said caller using a calling device with an audio receiver;
receiving transaction information between the caller and the merchant from the merchant;
sending the caller identification and at least some of the transaction information to a payment gateway, wherein the caller's sensitive financial information is stored in a memory accessible, using the caller identification, by the payment gateway and not accessible by the merchant; and
receiving, from the payment gateway, a payment confirmation or rejection from the payment gateway, and sending the payment confirmation or rejection to the merchant.

12. The method of claim 11 further comprising receiving a caller authentication of the caller through the interactive voice response system and sending the caller authentication to the payment gateway.

13. The method of claim 12 wherein the caller authentication is a personal identification number (PIN) or password that is spoken by the caller to the interactive voice response system.

14. The method of claim 12 wherein the payment gateway uses the caller identification and the caller authentication to access the caller's account, wherein the caller's account includes the caller's sensitive financial information, wherein the sensitive financial information comprises one or more of the following: caller's credit card number, debit card number, prepaid card number, gift card number, or bank routing number.

15. The method of claim 11 wherein the caller identification is a phone number of the calling device that the caller is dialing from.

16. The method of claim 12 further comprising storing, in one or more memory storage units, the caller identification, the caller authentication, and the transaction information.

17. The method of claim 16 further comprising storing, in the one or more memory storage units, a time value at which the caller authentication is generated or received, wherein the time value is associated with the caller authentication, and wherein the time value is determined with aid of a local server clock.

18. The method of claim 17 further comprising removing, from the one or more memory storage units, the caller authentication after a predetermined period of time has elapsed from the time value stored in the one or more memory storage units.

19. The method of claim 18 further comprising connecting the caller with the merchant based on a spoken merchant identifier, said spoken merchant identifier recognized via the interactive voice response system.

20. The method of claim 19 wherein the caller communicates with the merchant during the transaction via spoken words without requiring use of a visual display or interface.
